(19) United States
(12) Patent Application Publication
(10) Pub. No.: US 2018/0174076 A1
(43) Pub. Date: Jun. 21, 2018

(54) Automated Property Management, Authorized Entry, and Reservation System Platform

(71) Applicant: Shuji Fukami, Tokyo (JP)

(72) Inventor: Shuji Fukami, Tokyo (JP)

(21) Appl. No.: 15/387,006

(22) Filed: Dec. 21, 2016

(51) Int. Cl. G06Q 10/02; G08B 13/196; H04L 29/06; H04W 12/06

(52) U.S. Cl. CPC G06Q 10/02; G08B 13/19695; H04W 88/02; H04W 12/06; H04L 67/42; H04L 63/0861

(57) ABSTRACT

A system and method for providing authenticated access for a user to a restricted physical space via a mobile device is described. The system employs a smartphone application, which facilitates a user's reservation of a selected seat and space within a shared space. The shared space is equipped with a lock interfaced with a secured server, which is configured to unlock upon an authenticated request for entry by a user with a reservation. Biometric and/or pin authenticated means of entry are provided via the application as well as a pin pad disposed on a control module. Sensors disposed in or near the seats available for reservation are configured to detect a human presence employing the reserved space, which confirm the presence of a user, and monitor unauthorized use. A timeclock of the server records the duration of time spent within the shared space, and bills users accordingly.

### FIELD OF THE PRESENT INVENTION

The present invention relates to a method of conveying information to be authenticated to bring about a result. More specifically, the present invention relates to a method of digitally providing access to one or more services pertaining to events in the physical or virtual world, including providing authenticated access to a physical door of a shared space via a mobile device, creating reservations for a seat within the physical space, and the digital monitoring of the use of the space to charge a user based on time spent therein.

### BACKGROUND OF THE PRESENT INVENTION

It is known that providing digital access to a structure via biometrics can be a beneficial means of ensuring security of the structure. Digital locks are known in the art, and are often equipped with the capacity to be opened with a fingerprint, or via a paired and/or verified mobile device. However, rarely do such locks employ multiple means of authenticating entry to the structure.

Shared workspaces are presently gaining popularity in large cities. They afford users the opportunity to meet with clients in a physical space, and share in the environment of an office, while enduring far lower costs than renting or owning a traditional private office. Employees that work from home, and/or are self-employed often take advantage of such public work spaces to be more productive, as well as for a change of scenery.

Conventionally, such shared work spaces are equipped with a staff, which is shared among the users of the shared work space. The staff is relegated to security, ensuring that those that enter the work space have permission, and that dues are paid for use of the facility. Additionally, staff is required to determine if cleaning is required, supplies are needed, and to answer phones (in shared offices that employ a shared phone line(s)). Unfortunately, the costs of such a shared staff tend to increase the cost to each user of the shared work space. If much of the staff required for managing and hosting a shared work space could be eliminated, the cost of operation of such a work space could be drastically reduced.

Thus, there is a need for a method by which a user may be provided access to a restricted area, such as a shared work space, by biometric authentication via a mobile device, which is monitored by an IP camera connected to the system such that the user may use the facilities of the restricted area upon authentication, and be charged according to the monitored time spent within the facility. Sensors disposed within seats employed within the restricted area, as well as power socket detectors functioning in tandem with at least on IP camera are configured to reliably determine the identity of the individuals entering the shared work space. Such a system is preferably configured to facilitate the reservation of individual seats, tables, rooms, or segments of rooms of the shared work space via the mobile device of the user.

Such a system is ideal for businessmen or people that do require to go an office, but wish to offset the commuting time to avoid rush hour before and after work. Users such as these can work in the shared work space from 8-10 then go to their office, or leave their office early, and work from 4-6 in a remote office. Similarly, solopreneur or freelancers can benefit from a work space occasionally, as such users may be more prone to work when surrounded by others working. Additionally, the system of the present invention is also ideal for telecommuters who no longer go to a headquarters office daily, and wish to use a shared workspace facility periodically, but do not want to be charged for a fully staffed shared work space.

### SUMMARY OF THE PRESENT INVENTION

The present invention provides a method and system of providing authenticated access to a structure, such as a shared workspace, via a lock mechanism in communication with a server. A user desiring access to the shared workspace employs his or her mobile device to connect to the server, and establishes an identity (user profile) via an application (app). The app facilitates wireless access to the server of the present invention, as well as employs a biometric authentication method to verify the identity of the user. At least one IP camera, in communication with the server, provides a second verification of the user upon attempting entry to a door equipped with the lock mechanism.

The lock mechanism of the present invention is configured to open when requested by an authenticated user making the request via the mobile device or via a control module positioned near the door, preferably disposed on both the inside and outside of the door. A fingerprint or other form of biometric authentication is preferably gathered via the mobile device, which is verified against existing data pertaining to the profile of the user stored on the server. In some cases, a pin may be provided to the user upon making a reservation, which may be used on a pin pad to facilitate access to the shared space, or a biometric reader may be present on the control module, adjacent to the pin pad. While unlocking, the at least one IP camera serves to ensure that the identity of the user entering the work space is the same as the identity of the profile via facial recognition. Additionally, the at least one IP camera is configured to ensure that only one individual enters through the door per unlocking instance.

The server is preferably configured to record each entrance instance and exit instance of the work space, and record the time spent within the work space for each user that enters. In this manner, the time tracking of the present invention functions similar to that of a conventional timeclock of a work place. Time that is monitored may then be charged to the user per a pre-established cost basis. Therefore, users are only billed for the time spent within the work space.

The app of the present invention is preferably configured to allow each user to select where and what type of work area (and seat) within the work space that he or she wishes to use. For example, one day, a user may desire to use a full conference room, whereas another day, he or she may only need one seat within a room, or a private work room. The app provides the user a means to select which seat and/or room that he or she desires to use. The desired work area is selected based on what work areas are presently available within the work space, which are shown via the app on a layout view screen. A room view screen is also available to facilitate the selection of an individual seat within an available room, and to show the environment within the room. The selection screen on the app is preferably visual, based on the feeds of the at least one IP camera disposed in each of the work areas of each of the rooms within the work space.

A seat weight sensor, proximity sensor, and/or heat sensor is preferably disposed in communication with each seat, which verifies when the user has reached his or her selected work area of the work space upon sitting down. Additionally, an optional AC plug monitor is configured to detect when the user plugs in at least one device, such as a computer or mobile device, to a power plug near the selected work area.

### BRIEF DESCRIPTION OF THE DRAWINGS

The present invention will be better understood with reference to the appended drawing sheets, wherein:

FIG. 1 exhibits a chart depicting the components of the present invention and their interaction during use of the present invention.

FIG. 2 depicts a screen shot of the mobile device application of the present invention, detailing the seat selection screen.

FIG. 3 depicts a screen shot of the mobile device application of the present invention, detailing the appointment time selection screen.

FIG. 4 depicts a screen shot of the mobile device application of the present invention, detailing the reservation screen for a conference room.

FIG. 5 displays a view of a conventional seat arrangement in a shared office environment, detailing the tagged spaces marked via software of the server interfaced with the cameras of the system of the present invention to detect when seats and spaces are in use.

FIG. 6 exhibits a close-up view of the front of the control module of the present invention.

FIG. 7 displays a flow chart depicting the process of use of the present invention from the viewpoint of a user.

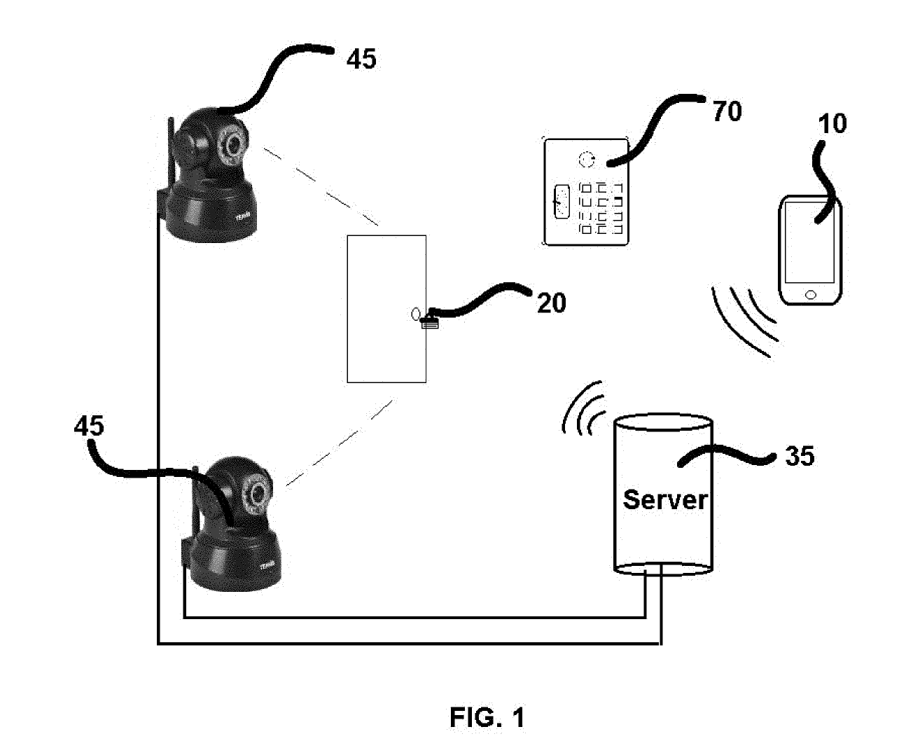

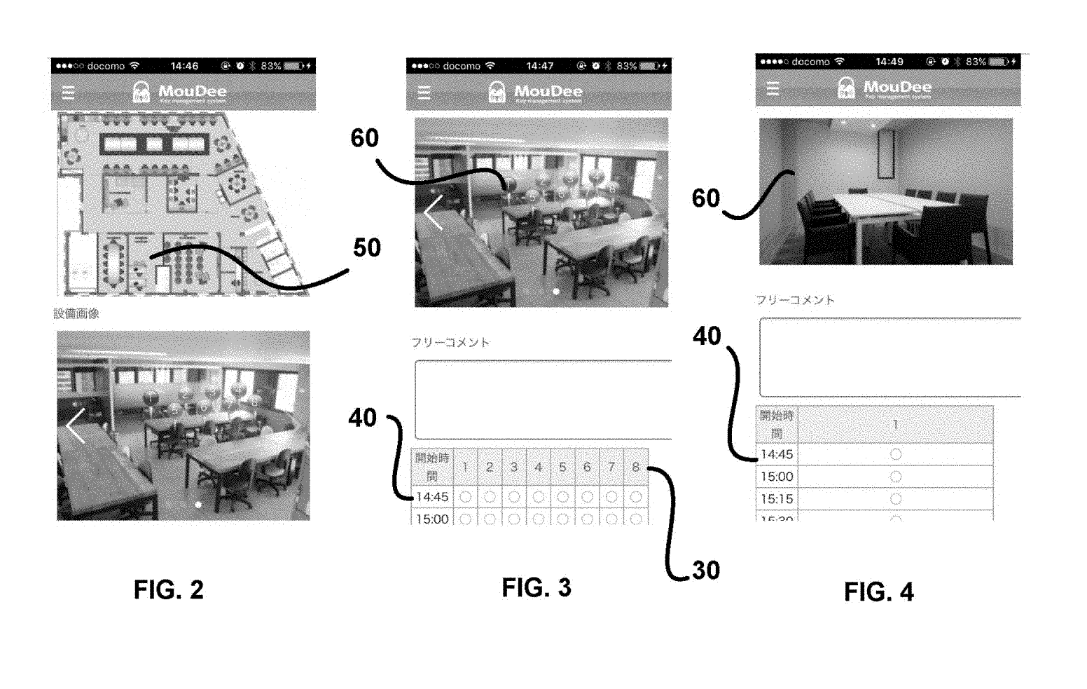

### DETAILED DESCRIPTION OF THE PREFERRED EMBODIMENT

The present invention is an authentication, communication, and access system configured for use within a shared structure, such as a shared office or workspace. The present invention enables the complete functioning of a shared workspace without the need for on-hand staff, removing the costs of a doorman, secretary, security, and other conventional office staff. The present invention consists of a mobile device application (10) or “app” configured to run on the mobile device of a user wishing to use the shared workspace. The app (10) is configured to connect to a server (35) via conventional wireless means, such as WiFi and/or Bluetooth™. The app (10) also facilitates the creation of a user profile for the user, which is preferably linked to the ID of the mobile device of the user, such as the IMEI, MAC address, or SIM number of the mobile device of the user. This serves as a first form of authentication of access to the shared work space, which verifies that the mobile device is in the hands of the owner or authorized user of the mobile device via biometric fingerprint identification. In the event that the mobile device is not configured to unlock from a lock screen of the device via fingerprint security unlock, the user is preferably prompted to employ a fingerprint to access certain features of the mobile application (10) of the present invention.

The user profile of the user is preferably linked to financial information of the user, such that the user may be charged according to recorded time spent within the work space. The app (10) additionally serves as a mechanism to record the biometric identity data of the user, such as a fingerprint, upon the request of access to the shared work space. The entrance (door) to the shared workspace equipped with the system of the present invention is preferably equipped with a network-connected lock (20), which is configured to automatically unlock upon receiving an authenticated request from the server (30) wirelessly. The door and work areas equipped with the system of the present invention are preferably equipped with at least one IP camera (45).

Upon logging in to the app (10) of the present invention, the user is presented with the option to manually select the nature and location of the work area that he or she desires to use within the shared work space. Work areas of the shared space may include a conference room, an individual work room, a seat within a shared work room, or other similar work areas. Each work area is visually displayed on the screen of the mobile device of the user upon logging in to the application under his or her user profile. Work areas are shown via the room view (60) screen. A layout view (50) screen preferably displays each individual work area as it relates to the floor structure of the building. Seats (75) or areas of the work space which are unoccupied are shown as available for reservation on the screen. Upon selection of the desired work area and/or seat, the user selects an appointment time via the appointment time selection field (40), at which point the user has effectively reserved the area for use.

The user may then request access to the door via the app (10), or via a control module (70) on site. The request is verified with the biometric identity data of the user, which is preferably stored on-file within the server for comparison. A fingerprint reader and/or facial recognition camera are preferably disposed within or in communication with the control module (70) to facilitate authorization for access. The identity of the user is optionally verified via facial recognition derived from the feed from at least one IP camera (45), which are preferably disposed throughout the work space, as well as disposed by the inside and outside of the door. However, in the preferred embodiment of the present invention, the at least one IP camera (45) are employed for false usage detection, as well as to aid in determining if a given seat or room is occupied.

A control interface, preferably via a computer or mobile device, disposed in communication with the server (30), enables an owner/proprietor of the work space (or other shared facility) to achieve seamless access to a management system. From the management system, via the control interface, the owner may determine which users may be afforded access to the work space, as well as when reservation times be made available for selection. It should be understood that users can only access properties (owned or controlled by the owner) during an available and selected reservation timeframe.

Additionally, it is envisioned that the property management company can set a buffer relating to who can use what portion of the work space on a specific date/time, as well as which seat (75) and room. Seats (75) are preferably numbered, and are referenced by the server (35) for reservations, as well as to reference seats (75) in use compared against seats (75) reserved. Work areas are monitored by at least one IP camera (45) to detect unauthorized usage.

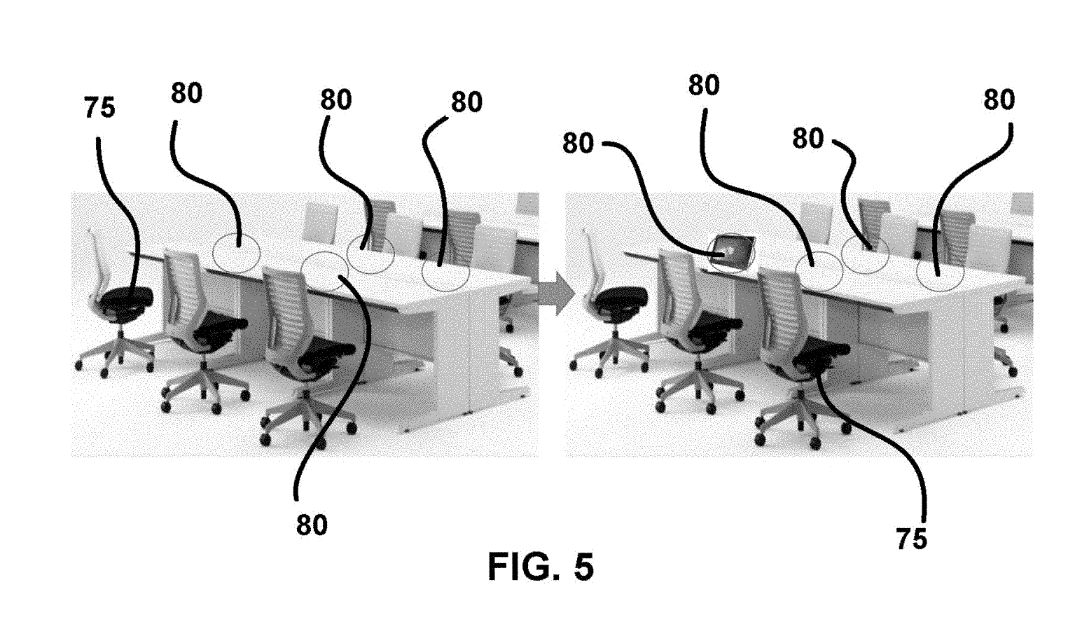

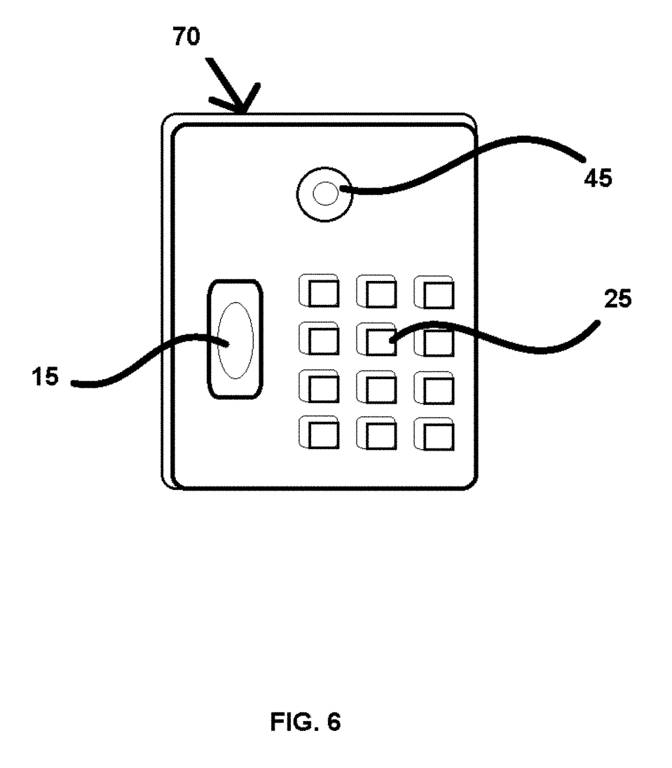

The at least one IP camera (45) is disposed in each work area of the shared space that is available for reservation. In these locations, the at least one IP camera (45) is oriented to face the table and seats (75), and is configured to detect color changes within tagged areas (80). Software running on the server (35) that is interfaced with the at least one IP camera (45) monitors these tagged areas (80), and the server records when a change in their appearance is detected, indicating use of the seat (75) accompanying the corresponding tagged area (80). For example, if the table of the work space is white, as shown in FIG. 5, the server (35) records when a different color is detected via the at least one IP camera (45) within the tagged area (80) corresponding to a specific seat (75), which are identified by number. The server (35) verifies that the tagged area (80), and therefore the corresponding seat (75), are only occupied by an authorized user (whom reserved that specific seat within the specific area) based on the video feed from the at least one IP camera (45). Additionally, In the event that it is detected that a seat (75) and/or tagged area (80) are in use without reservation, or are in use by the incorrect user, property management is alerted. In short, the software of the present invention, running on the server (35) of the present invention, is configured to segment a video feed from the at least one IP camera (45) into several tagged areas (80) corresponding to seats (75), which are synchronized with a reservation database of the server (35), to detect and verify appropriate (reserved) or fraudulent usage of a seat/area of the shared space.

In order for the at least one IP camera (45) of the present invention to remain effective, angles of the at least one IP camera (45) are carefully positioned, as position is critical to optimal functionality. Additionally, it is beneficial if the work space is equipped with a high ceiling. In facilities not equipped with a high ceiling, additional iterations of the at least one IP camera (45) are required, potentially requiring one camera for every four seats.

Additionally, the system of the present invention is also envisioned for use in service salons, such as tanning salons. An owner/proprietor of a salon facility located in a high usage city can employ the present invention to increase profits and standardize the facility to standardize service level without salon owner involvement. The system of the present invention may be licensed to salon owners. Salon owners can franchise their own facility quickly via automation afforded via the system of the present invention.

This platform allows current clinic or salon owner to generate extra revenue. But most importantly, property investors can invest into facility and allow service provider (freelancer service provider) to use its facility. The owner of the facility can collect a usage charge (as rent), or may opt to collect a specific percentage of sales generated within the salon or similar facility.

It is envisioned that consistent use of the system of the present invention will dramatically increase ROI as the property can operate 24/7 without need for staff monitoring or interference. As such, a single facility can provide a wide variety of service and languages. In implementations such as these, quality does not belong to the brand of salon or shared work space, but belongs to the service provider.

The access and reservation management features of the app (10) of the present invention functions similar to a conventional punch card, which allows owners of the work space to provide a variation of pricing according to physical time spent within the work space. Consistent use of the present invention is envisioned to maximize the value of the property and achieve the ‘break-even’ point within 2 years of opening the facility.

Effectively, it should be understood that there are two definitions of security for the present invention: access security (for access via the network-connected lock (20), and false usage security (reservation-to-seat match confirmation). Access security depends on mobile device security, as well as the security provided by the control module (70) via biometric and/or pin-based entry. False usage security is in place so that the system may effectively recognize and verify that only the correct reserved seat is used by the user who indeed reserved the seat in use. In other words, the system of the present invention is configured to recognize and alert property management when non-reserved seats are detected as in use by an unauthorized user.

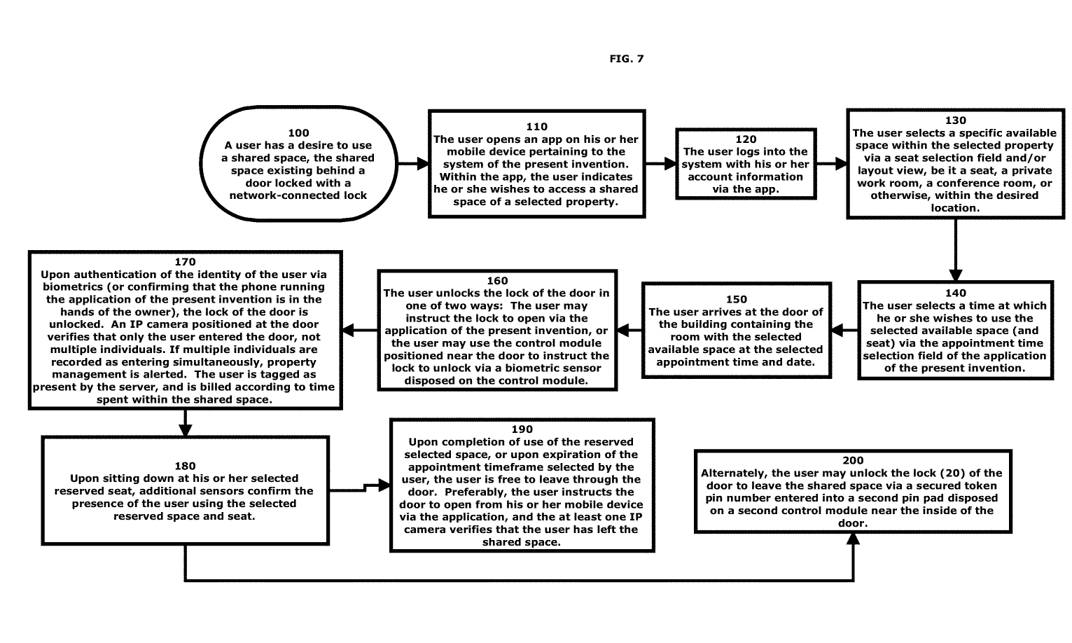

The process of installation and use of the present invention, as depicted in FIG.7, is preferably as follows:
1. A user has a desire to use a shared space, the shared space existing behind a door locked with a network-connected lock (20). (100)
2. The user opens an application (app) on his or her mobile device pertaining to the system of the present invention. Within the app, the user indicates he or she wishes to access a shared space of a selected property. (110)
3. The user logs into the system with his or her account information via the app (10). (120)
4. The user selects a specific available space within the selected property via a seat selection field (30) and/or layout view (50), be it a seat, a private work room, a conference room, or otherwise, within the desired location. (130) Available spaces are shown via a layout view diagram (50) and/or photo of the space showing a room view (60).
5. The user selects a time at which he or she wishes to use the selected available space (and seat) via the appointment time selection field (40) of the application (10) of the present invention. (140)
6. The user arrives at the door of the building containing the room with the selected available space at the selected appointment time and date. (150)
7. The user unlocks the lock (20) of the door in one of two ways: The user may instruct the lock (20) to open via the application (10) of the present invention, or the user may use the control module (70) positioned near the door to instruct the lock to unlock via a biometric sensor disposed on the control module (70). (160) The user employs biometric authentication via the control module or mobile device (such as with facial recognition or fingerprint) to verify the identity of the user, which is compared against known biometric data by the server, which instructs the lock to unlock if the biometric data matches, and the user has arrived at the time of the appointment. Alternately, a rotating token pin may be employed to unlock the lock (20), which is preferably provided to the user via the application (10). A pin pad (25) is preferably present on the control module (70) to facilitate unlocking the lock of the door with a pin. Alternately, the control module (70) may be equipped with a biometric fingerprint reader (15), which may be used instead of a pin in some installments of the present invention.
8. Upon authentication of the identity of the user via biometrics (or confirming that the phone running the application of the present invention is in the hands of the owner), the lock (20) of the door is unlocked. An IP camera (45) positioned at the door verifies that only the user entered the door, not multiple individuals. If multiple individuals are recorded as entering simultaneously, property management is alerted. The user is tagged as present by the server, and is billed according to time spent within the shared space. (170)
9. Upon sitting down at his or her selected reserved seat (75), additional sensors confirm the presence of the user using the selected reserved space and seat. (180) Sensors preferably include a weight/pressure sensor disposed within the seat (75), a heat detector (heat sensor) disposed within the seat (75), a proximity sensor disposed in or near the seat (75), and/or a AC power detector, configured to detect usage of an AC power outlet disposed at each seat (75). Similarly, if the reserved space is equipped with a personal lamp, the AC power detector observes when the lamp is turned on, and conveys usage data to the server.
10. Upon completion of use of the reserved selected space, or upon expiration of the appointment timeframe selected by the user, the user is free to leave through the door. Preferably, the user instructs the door to open from his or her mobile device via the application (10), and the at least one IP camera (45) verifies that the user has left the shared space. (190) Alternately, the user may unlock the lock (20) of the door to leave the shared space via a secured token pin number entered into a second pin pad (25) disposed near the inside of the door. (200) The pin number is provided to the user via his or her mobile device via the app (10).

The system of the present invention is preferably equipped with features configured to detect if and when an individual accesses or attempts to access the shared space without authorized entry, such as following a paying customer into the shared space when the door is opened by the paying customer. IP cameras (45) disposed inside and outside of the door are preferably configured to detect the number of individuals entering. The server (35) compares the number of individuals detected against the number of individuals who have paid or otherwise been authorized for entry. In the event that an unauthorized individual is witnessed by the IP camera (45), property management is alerted.

During the unlocking procedure for the lock (20), the mobile device of the user conveys an unlock/authentication signal to the server (35) via to a control panel, which relays the unlock signal to the lock (20). Upon authenticating the request, the server (35) instructs the at least one IP camera (45) to activate in burst photo mode, and instructs the lock (20) to unlock simultaneously. In the event that the at least one IP camera (45) (upon activated by the server during entry) observes via facial tagging that two or more people enter when only one should have entered through the door, property management is alerted. Ideally, entry and exit of the property equipped with the system of the present invention is limited to one individual per access, or one facial tag per one authenticated entry (unlocking instance of the lock (20)).

For multiple reservations, such as if a user wishes to reserve multiple seats within the same room for small group work, a single specific user may opt to reserve multiple seats. In such instances, the user makes several reservations within the same time frame, effectively reserving seats on behalf of others. Billing for the seats is directed towards the singular account of the specific user who made the reservations, and entry protocol is revised to not alert property management when multiple individuals arrive and enter simultaneously when the specific user requests entry during the reserved appointment time.

It is envisioned that reservations for a seat and space within the shared space may be made for any date and time in the future, however the span of reservation times available to users is preferably set by property management (i.e. reservations may be made up to six months into the future, or however long deemed fit by property management.)

Having illustrated the present invention, it should be understood that various adjustments and versions might be implemented without venturing away from the essence of the present invention. Further, it should be understood that the present invention is not solely limited to the invention as described in the embodiments above, but further comprises any and all embodiments within the scope of this application.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment was chosen and described in order to best explain the principles of the present invention and its practical application, to thereby enable others skilled in the art to best utilize the present invention and various embodiments with various modifications as are suited to the particular use contemplated.

I claim:

1. An automated system for property management comprising:
a shared space, the shared space existing behind a door locked with a network-connected lock;
first, opening an application on a mobile device, the application facilitating a connection to a server interfaced with the network-connected lock;
second, the application displaying a map the shared space, including rooms and seats available for use via reservation;
third, selecting a desired room by tapping the image of the room within the map on a screen of the mobile device via the application;
fourth, selecting a desired seat within the desired room;
fifth, selecting a reservation time via a reservation time selection field displayed in the application;
sixth, arriving at the door locked with the network-connected lock at the selected reservation time
seventh, confirming identity via a biometric reader on the mobile device;
eigth, the server authenticating the identity;
ninth, the server instructing the network-connected lock to unlock;
tenth, the server instructing at least one IP camera to record video via burst photo mode simultaneously with the network-connected lock unlocking;
eleventh, entering the shared space through the door while being monitored by the at least one IP camera;
twefth, the server recording the time at which the shared space was entered;
thirtheenth, the server detecting the number of individuals passing through the door based on the recorded video from the at least one IP camera;
fourteenth, the server alerting property management personnel in the event that the number of individuals passing through the door is greater than one;
fifteenth, proceeding to the selected room;
sixteenth, sitting at the desired seat;
seventeenth, the at least one IP camera verifying use of the desired seat such that the at least one IP camera is disposed in each work area of the shared space, oriented to face the desired seat, detecting color changes at the desired seat to determine that the desired seat is occupied by an authorized user;
eighteenth, the at least one IP camera detecting use of an unreserved seat such that the at least one IP camera is disposed in each work area of the shared space, orientied to face the unreserved seat, detecting color changes at the unreserved seat to determine the seat is in use without a reservation;
then, the server marking the desired seat as occupied on the map when the desired seat is occupied by the authorized user;
then, the server marking the unreserved seat as occupied on the map when the unreserved seat is in use without a reservation;
weight/pressure sensors, disposed within at desired seat and the unreserved seat, detecting use of the desired seat and the unreserved seat
heat detectors, disposed at the desired seat and the unreserved seat, detecting use of the desired seat and the unreserved seat
proximity sensors, disposed at the desired seat and the unreserved seat, detecting use of the desired seat and the unreserved seat and
AC power detectors, disposed at AC power outlets at the desired seat and the unreserved seat, detecting use of the desired seat and the unreserved seat.

2-3. (canceled)

4. The system of claim 1, further comprising:
wishing to leave the shared space;
proceeding to the door locked with the network-connected lock;
approaching a control module disposed near the inside of the door;
wherein the control module is in communication with the server and the network-connected lock;
wherein the control module is equipped with a pin pad;
the application providing a pin code to the user displayed on the mobile device;
inputting the pin code on the pin pad of the control module;
the server authenticating the pin code;
the server instructing the network-connected lock to unlock upon pin code authentication;
opening the door, leaving the shared space;
the server recording the time at which the shared space was left; and
the server billing according to the time physically spent within the shared space.

5. The system of claim 4, further comprising:
the at least one IP camera verifying that the shared space has been left.

6. The system of claim 1, further comprising:
the at least one IP camera verifying use of a room such that the at least one IP camera is disposed in the room, detecting color changes in the room to determine that the room is either occupied or unoccupied; and
then, the server marking the room as occupied on the map when the room is occupied.
